(19) United States
(12) Patent Application Publication
(10) Pub. No.: US 2006/0234007 A1
(43) Pub. Date: Oct. 19, 2006

(54) Device for the protection against and detection of impacts on the edges of a layered composite structure

(76) Inventors: Yves Durand, Toulouse (FR); Jean-Luc Leon-Dufour, Saint Lys (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/120,931

(22) Filed: May 3, 2005

(30) Foreign Application Priority Data
May 4, 2004 (FR) 04 50857

(51) Int. Cl. B32B 3/04

(52) U.S. Cl. 428/122

(57) ABSTRACT

The object of the invention is a device for the protection against and detection of impacts on the edges of superimposed layers (2) of a composite structure (1), in particular integrally stiffened panels with stiffeners (3), wherein a U-shaped edge shield (5) encloses an edge to be protected (4) and is bonded to the latter by any appropriate means.

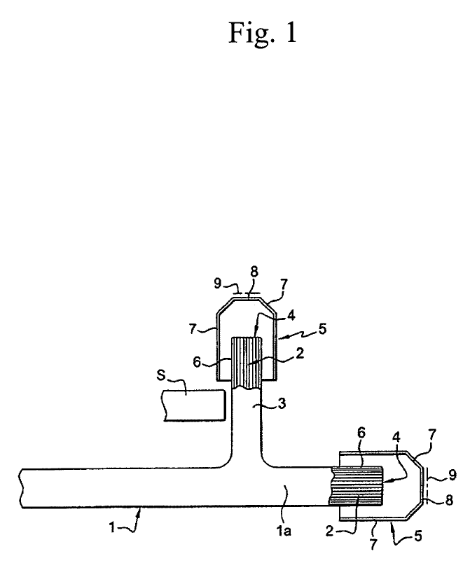

The present invention concerns the protection of edges in composite material structures formed using superimposed layers, in particular integrally stiffened panels with stiffeners.

This type of panel is widely used in the aeronautical industry to form various structures such as wing box panels or bulkhead walls.

These panels are primarily rated for compression by three criteria: stability, filled-hole compression, and damage tolerance.

The rating is obviously determined by the most significant criterion.

The third criterion, damage tolerance, is particularly stringent with respect to limitations on the elongation of such panels. The elongation problem predominates for a thick panel such as a wing box upper surface that operates with a high level of stretch. The same problem is encountered, but to a lesser degree, with a bulkhead wall panel that is subject to air or fuel pressure, which operates primarily by bending.

In the first case of a box section panel with a thickness of more than 15 mm, the stability criterion is not critical, and the high level of stiffness enables the avoidance of flammability. The second criterion is not critical, as impact energies (between 35 and 90 joules) do not cause delamination throughout the thickness and hence do not significantly reduce what is acceptable in terms of compression. The panel may therefore be rated on the basis of filled-hole compression, i.e. at a level on the order of −4000 μd (microdeformations).

In contrast, an impact on the edge of a stiffener at energy levels of the order of 35 joules may cause delamination throughout the thickness of the stiffener and thus reduce the allowable elongation to a level of between −3000 and −3500 μd.

Damage tolerance therefore imposes a reduction in the elongation limit for this type of panel that requires increasing the thickness of the panel and/or stiffener, and consequently the overall weight, to take account of any potentially damaging impacts on the edges of the panels or their stiffeners, which might not be detected or detectable.

The present invention aims to reduce the critical nature of this damage tolerance criterion by suggesting a suitable method for the detection of both the presence of an impact and the potential of this impact to render the affected panel unsuitable for its intended use, thereby enabling an increase in elongation tolerance, leading to the possibility of reducing panel thickness and hence weight when compared with a conventional panel, other operating conditions being equal.

The invention also aims to protect said panel edges from impacts.

To this end, the object of this invention is a method for the protection and detection of impacts to the edges of layered composite structures, and in particular panels integrally stiffened with stiffeners, in which a U-shaped edge shield encloses the edge to be protected and is firmly attached to the latter by an appropriate means.

Such an edge shield could advantageously be constituted from a block of polymethacrylimide, and in particular the material commercialized under the name ROHACELL® by Rohm and distributed in France by Gache Chimie.

The outer surface of the edge shield could possibly be covered by a protective film enclosing the shield, using a glass or Kevlar® film.

The edge shield could also advantageously be coated at least partially with an impact-detecting paint, which would thus indicate the need for the panel to be checked, for example by using conventional ultrasound techniques.

Bonding between the edge and the edge shield could be achieved using an appropriate adhesive material such as a gluing adhesive.

Other characteristics and advantages will emerge from the description that follows of the methods used to produce the edge shield of this invention; this description is given for illustrative purposes only and refers to the attached drawing showing a partial cross section of a multilayer composite panel with stiffeners.

In this drawing, 1 is a partial schematic representation of an integrally stiffened composite panel constituted from plate 1a that is formed of superimposed layers 2. Item 3 is a stiffener, either integrated with plate 1a or added to the latter and also consisting of superimposed layers 2.

The edge 4 of plate 1a and stiffener 3 are inherently areas that are more fragile and susceptible even to impacts of low energy, for example impacts with energies of between 30 and 35 joules.

These impacts, which may not be discernible to the eye, may have highly damaging consequences such as delamination throughout the thickness of edge 4.

In order to reduce this risk and to protect edges 4 according to this invention, the latter are covered permanently by U-shaped edge shield 5 that encloses the edge to be protected.

Edge shield 5 can be made of any appropriate material, particularly a material that offers adequate strength and is light as possible.

As such panels 1 may be in contact with hydrocarbons, the material for edge shields 5 must also be resistant to such contact.

A plastic material such as a rigid, closed-cell polymethacrylimide foam such as ROHACELL® commercialized by Gache Chimie is particularly suitable.

The attachment of edge shields 5 mounted on the edges of plate 1 and stiffener 3 is achieved by any method, for example, by bonding using adhesive or mastic 6 such as an interposed polysulfone adhesive such as the product commercialized by PRC Aerospace.

The outer surface of the edge shield 5 can advantageously be coated with protective film 7, for example of glass or Kevlar®.

Finally, face 8 of the edge shield 5 parallel to edge 4 may be coated with impact-indicating paint 9.

A simple and rapid visual inspection will therefore suffice to detect the presence of an impact and to initiate a check using, for example, ultrasound detection, indicated by S, which need only be applied to the identified area.

Throughout the life of the equipment, a simple visual check of the panels will thus enable the detection of the presence of an accidental impact occurring during a maintenance operation and will initiate a fitness check of the material using ultrasound to confirm the absence of delamination, and will prompt a repair if delamination is found.

Indicator paint 9 is not essential if the nature of the material used to make edge shields 5 or its surface state permits similar visual indications of any impact to be made.

When edge shield 5 is made of a closed-cell material, these cells contribute to attenuating any impacts. The presence of external film 7 is also intended to contain the cells during an impact.

Thus, when edge shield 5 shows signs of an impact, the damaged area can be repainted, or it can simply be replaced.

The presence of edge shields 5 will enable a drastic reduction in the damage tolerance criterion and will reduce the weight of the structures concerned by at least 15% for panels such as wing boxes, with a slightly less but still significant gain for panels that do not operate at the same elongation levels, such as cabin bulkhead panels or access areas such inspection hatch rims that operate more in bending modes. In all cases, the presence of edge shields 5 will permit the elimination of routine ultrasound checks.

1. A device for protection against and detection of impacts on the edges of superimposed layers of composite structures, in particular integrally stiffened panels with stiffeners, wherein a U-shaped edge shield encloses an edge to be protected and is firmly attached thereto, with the outer surface of edge shield being covered by a protective film that envelopes said edge shield.

2. The device as recited in claim 1, wherein said device is formed from a block of a foam of a closed-cell plastic material.

3. The device as recited in claim 2, wherein the plastic material is the polymethacrylimide commercialized under the name ROHACELL®.

4. The device as recited in claim 1, wherein a protective film is formed of glass or Kevlar®.

5. The device as recited in claim 1, wherein an edge shield is coated at least partially with an impact-indicating paint.

6. The device as recited in claim 1, wherein an edge shield is bonded using an appropriate adhesive or mastic.
